(19) United States
(12) Patent Application Publication
(10) Pub. No.: US 2007/0271184 A1
(43) Pub. Date: Nov. 22, 2007

(54) Technique for Transferring Media Data Files

(76) Inventors: Norbert Niebert, Aachen (DE); Frank Hartung, Herzogenrath (DE); Ralf Keller, Wurselen (DE)

Correspondence Address: ERICSSON INC., 6300 LEGACY DRIVE, M/S EVR 1-C-11, PLANO, TX, 75024, US

(21) Appl. No.: 10/596,529

(22) PCT Filed: Dec. 16, 2003
(86) PCT No.: PCT/EP03/14328

§ 371 Date: May 10, 2007

(51) Int. Cl. H04L 29/06

(52) U.S. Cl. 705/51

(57) ABSTRACT

A technique is disclosed for transferring at least one of a media file and associated usage rights data from a first user unit (110) to a second user unit (120), wherein the media file is identifiable by a central interface (130) unit and includes at least one component of image data, audio data, and video data. Utilizing a communication link between the first and second user units (110, 120), at least one of the media file and the associated usage rights data is transferred from the first user unit to the second user unit, the access by the first user unit (110) to the media file is limited, and the second user unit (120) is provided access to the media file. Subsequently, at least one of the first and second user units (110, 120) is coupled over a communications network to the central interface unit (130) so that the transfer of at least one of the media file and its associated usage rights data from the first user unit (110) to the second user unit (120) may be logged.

### FIELD OF THE INVENTION

The invention relates to communications. More specifically, the invention relates to a technique for transferring at least one of a media file and its associated usage rights data between two user units.

### BACKGROUND OF THE INVENTION

Trading cards are traded and exchanged in forums varying from swaps between school children to Internet-based portals facilitating their transfer. The interest in trading cards is premised on the fact that certain trading cards are more desirable than others, and thus there is a higher demand. The corresponding supply (or lack thereof) of desirable cards is integral to set a value based for such trading cards. This supply and demand relationship may be globally based if the market for a particular card is especially liquid, or it may be relatively small if the trading cards are being exchanged within a small population. Notwithstanding, the trading of cards is individualistic in nature as it is dependent upon the trader's personal valuations of a particular trading card. In addition, the interaction between traders is an important factor for facilitating trades and for placing values on certain trading cards.

As technology has advanced, more companies and individuals are producing digital trading cards that contain media data such as images, video, and audio. A digital trading card may be offered for a wide variety of situations such as an incentive to purchase a product in a store (e.g., soda, candies, etc.), a reward for Internet-based purchases, in exchange for the redemption of frequent customer points (such as frequent flyer miles or other awards for use-based activities), or digital trading cards themselves may be directly sold to customers. For example, users of the Magic the Gathering brand products may purchase, trade, and exchange digital trading cards via a manufactured sponsored website. With this arrangement, trades of digital trading cards are typically conducted via an online forum provided by the producers of the digital cards or other service providers. However, compared to conventional printed trading cards, digital trading cards have not been widely adopted, based in part, on the ability for users to duplicate most digital trading cards (and thus increasing the supply of digital trading cards and reducing the corresponding demand).

WO 92/50752 describes an arrangement for digital trading cards where a user may interact with other users over a communications network, such as the Internet, to review, trade, and otherwise exchange digital trading cards. While this arrangement permits trading in some circumstances on a central system, the techniques for transferring digital cards are limited.

Consequently, there is a need for a technique for efficiently transferring digital trading cards, embodied in a media file, as well as information regarding the usage data rights for such media files.

### SUMMARY OF THE INVENTION

The invention is embodied in a method for transferring at least one of a media file (such as a digital trading card) and associated usage rights data from a first user unit to a second user unit. The media file is identifiable by a central interface unit and comprises at least one component of image data, audio data, and video data. It may comprise additional information relevant to the media file, such as display interface information and any other text describing the media file.

The method includes the initiation of a communication link between the first and second user units (either directly or through a data communications network). Once this communication link is established, at least one of the media file and the associated usage rights data is transferred directly from the first user unit to the second user unit. Once the media file and/or the associated usage rights data is transferred, the access by the first user unit to the media file is limited (this may be initiated by the first user unit or a device external to the user unit in communication with it) and the second user unit is provided access to the media file. At least one of the first and second user units is coupled over a communications network to the central interface unit. The central interface unit logs the transfer of at least one of the media file and its associated usage rights data to the second user unit. If required, the above steps may be performed in any order.

The media file may be used to convey images (as an analogue to conventional paper trading cards), audio (such as a rare song or other audio clip), video, or other information that may be conveyed visually and/or orally (like holographic images, 3-D models or characters, etc.). The associated usage rights may provide the required information to access the media file by a user unit. In some variations, the associated usage rights data may provide certain restrictions on the use of the media file associated therewith or it may provide other information regarding the media file (such as identification and access information).

The receiving user unit may have unlimited access to the media file after the transfer, or it may have rights to access portions of at least one of the media file and the associated usage rights data as specified by the transferring user unit. The transferring user unit may also maintain some form of access after the transfer of at least one of the media file and associated usage rights data to the underlying media file, again, contingent upon the restrictions, if any, placed on the access and usage of the media file by the receiving user unit.

In some embodiments, the method further comprises the step of retrieving, by the second user unit, either the media file or the associated usage rights data, not transferred from the first user unit to the second user unit, from the central interface unit. This allows some arrangements where only one of the media file and the associated usage rights data is transferred directly, and the remaining file or data is retrieved from the central interface unit (or any other storage device that may be accessible to a receiving user unit).

The central interface unit may also be accessed by a user independently of his or her mobile phone, and in such variations, the central interface unit may store copies of the media files that can be accessed through the website (and correspondingly limiting a user from accessing these media files after a media file has been transferred). The central interface unit may simply provide information regarding the transfers and media files currently associated with a user unit, as well as any related account information for each user from the central interface unit service provider. The central interface unit may also oversee all transactions between user units and repudiate transfers, if required.

The method may also comprise a swap transaction where the second user unit has at least one second media data file and associated usage rights data in connection therewith. Similar to the initial transfer, the second user unit transfers at least one of the second media file and its associated usage rights from the second user unit to the first user unit. After the transfer, the method limits access by the second user unit to the second media file, and provides access to the first user unit to the second media file. In addition, the transfer of at least one of the second media file and its associated usage rights data from the second user unit to the first user unit is logged at the central interface unit (which may occur as part of the logging step for transferring the first media file from the first user unit to the second user unit, or it may occur separately). In some variations of a swap transaction, a transferring user may transfer two or more media files and associated usage rights in exchange for one or more media files.

If the method is part of a swap transaction, the method may be configured such that the transfer of at least one of the first media file and its associated usage rights data to the second user unit is conditioned upon the transfer of at least one of the second media file and its associated usage rights data to the first user. Therefore, if the second user unit does not transfer the second media file after simultaneous or prior to the transfer of the first media file from the first user unit to the second user unit, then the transaction may be cancelled or voided and the transferred media files being returned to their original user units (similar cancellation or voiding of transactions may also be utilized in connection with usage restriction requirements associated with a media file and the termination of a transfer by one of the user units). Alternatively, if a transfer is to be reversed, for whatever reason, the respective user units may simply be reset so that they do not reflect that the aborted or cancelled transfer (and the transferring user units continue to have access to the media files that were to be transferred).

If a swap transaction arrangement is being utilized, there may be situations in which the first user unit wishes to send a media file to the second user unit, but the second user unit does not have a media file to swap and so absent a corrective measure, the swap transaction would not be fulfilled. As a solution to this problem, the method may also include the step of generating a dummy data file (and for dummy usage rights data) to substitute as at least one of the second media file and its associated usage rights data to satisfy the swap transaction conditions. In other words, the second user unit may generate a blank or other media file containing minimal content (a “dummy”) to satisfy the condition of a media file being transferred in exchange for the one being received by the second user unit.

In another embodiment of the invention, the method further comprises the steps of generating an acknowledgment receipt by the receiving user unit after receipt of the media file, and transferring an acknowledgment receipt from the receiving user unit to the transferring user unit after the media file is transferred from the transferring user unit to the receiving user unit. The acknowledgement receipt may be a simple message confirming a successful transfer, or it may also be a dummy media file if there is a requirement for a swap of media files.

The current invention may also provide that each user unit has storage unit, an input buffer, and an output buffer. With such arrangements, the method may further comprise the steps of transferring the media file to be transferred from the storage unit of the transferring user unit to the associated output buffer, and transferring the media file to be transferred from the output buffer of the transferring user unit to the input buffer of the receiving user unit. This arrangement can allow for a more efficient and rapid transfer of at least one of the media file and its associated usage rights data.

Even if the method does not involve a swap transaction, the transfer of at least one of the media file and the associated usage rights data may be contingent upon a ratification of the transfer. This ratification may include simple criteria such as determining whether the transmission of the at least one media file and associated usage rights data was successful, and it could also be based on user-defined criteria (which may in some cases be incorporated into the associated usage rights data), or it may be ratified based on a verification that the transferring user unit has rights to the underlying media file. The ratification may comprise the step of comparison of a hash associated with at least one of the media file and the associated usage rights data. For example, ratification (which in this instance is equivalent to an authorization) may be contingent upon factors such as age of recipient so that young children are not able to inadvertently receive media files containing adult content. The ratification step may also determine whether there are any transfer restrictions on a media file that is either about to be transferred or has been transferred to ensure that a media file is not transferred in violation of such restrictions. A restriction on transfer may be embodied in a flag within either the media file or the associated usage rights data that indicates whether or not a card may be transferred (and the flag may also be used to provide or limit access such as after a user unit has transferred a media file). In some embodiments, only the central interface unit may change the status of this flag.

In addition or as an alternative to ratification, the method may further comprise the step of determining whether the media file is transferred with one or more usage restrictions. If the media file has been transferred with a usage restriction, then the method may further comprise the step of transferring the transferred media file from the receiving user unit back to the transferring user unit after a predetermined usage restriction condition associated with the transferred media file has been met. This arrangement allows for more flexible transactions in connection with the transfer of a media file. For example, the user may lend a media file for use by a third party user unit for a fixed period of time. In other cases, the user may sell its media file and so the transfer would be contingent upon receipt of the applicable payment (which could be accomplished electronically or entered manually the transferring user) in an account associated with the transferring user. The user may also restrict the number of occurrences that a media file may be accessed before the media file is transferred back to the transferring user unit.

The logging step at the central interface unit may comprise at least one of the steps of updating of a transfer log associated with the transferring user unit to reflect the removal of the media file, and updating a transfer log associated with the receiving user unit to reflect the addition of the transferred media file. In the alternative, the central interface unit may maintain logs regarding particular media files rather than particular user units so that transfers of media files are logged (which may or may not include the identities of the transferring and receiving user units).

In one embodiment of the invention, the method includes interactions with a digital rights management system. The digital rights management system may be part of the central interface unit or it may be a separate component. Preferably, the digital rights management system provides oversight to the method so that it prevents the duplication (including pirating) of any media files (i.e., does not allow both the first user unit and the second user unit to both have access to the same media file). In connection with the above method, if a digital rights management system is utilized, the method may also include the steps of polling the digital rights management system by at least one of the transferring and receiving user units, receiving a command from the digital rights management system by the transferring user unit to limit access by the transferring user unit to the transferred media file, and receiving a command from the digital rights management system by the receiving user unit to grant access to the receiving user unit to the received media file.

If the digital rights management system approves (meaning that one or more of the user units communicated with the central interface unit prior to the transfer of at least one of the media file and the associated usage rights data in connection therewith) or otherwise endorses (meaning that one or more the user units first communication with the central interface unit subsequent to the transfer of at least one of a media file and its associated usage rights data) a transfer of a media file, a restriction associated with the transfer of the media file may be removed. However, the digital rights management system may also prevent access to a transferred media file by a receiving user if the digital rights management system has associated the transferred media file with a third party (or user unit meaning that someone else owns the media file or it appears that someone has hacked the media file and made unauthorized duplications).

Depending on the digital rights management system utilized, the method may include the step of cryptographically associating each transferred digital media data file with the receiving user unit. This cryptographic association prevents unauthorized users from accessing the media file outside of the user unit cryptographically associated with the media file.

Each user unit may also include a data management application with manages the transfer and receipt of media files. The data management application may oversee the interrelation of the various components within each user unit that oversee the receipt, storage, and transfer of media files and associated usage rights data.

In some embodiments, the method includes the steps of providing a history log for integration into each media file that identifies previous owners and transfers of the media file, and synchronizing the media file history log with the logged transfers stored within the central interface unit. The history log may also maintain the current location of each media files (i.e., which user unit is currently associated with a particular media file). With this arrangement, the provenance of a certain media file is known and maintained in associated with the media file. While the history log may not be useful to most users, for valuable media files, it provides a useful information that may be used to judge the authenticity of the media file both electronically (whether by the central interface unit or some other verification application or service), or by an intended recipient of the media file.

The method may include the step of periodically communicating, by the central interface unit, with individual user units to synchronize at least one of the media files and the associated usage rights data, if any, stored within a particular unit, with one or more databases within the central interface unit. The synchronization step (which may occur after each transfer or upon other user defined criteria, such as every week, every 10^{th} transfer or receipt allows for the central interface unit to contain identical information regarding ownership and transfers as provided in the media file history log (or other information that may be useful to synchronize with the central interface unit or other devices maintaining records associated with the media files). In order to minimize the space needed to store the history log, some variations provide that the history log for each media file is emptied after synchronization with the central interface unit. If the history log has been emptied, then the central interface unit may need to be subsequently accessed if there is ever a question regarding the authenticity of the media file.

The current invention may be implemented in connection with one or more mobile communications devices. These mobile communications device may establish communications links between units using a wireless protocol such as Bluetooth, infrared, etc., or they may establish a communication link using a network such as WLAN, cellular networks, etc. Preferably, the mobile communications devices contain graphical and/or audio interfaces which allow them to display or otherwise convey the content contained within a media file.

The current invention may also be embodied in a system for transferring a media file that includes at least one component of image data, audio data, and video data, and associated usage rights data. Such a system would include first and second user units both configured to store at least one digital media file. The first and second user units are configured to initiate a direct communications link between the first and second users to transfer at least one of a media file or associated usage rights data therebetween. A central interface unit that is configured to communicate with at least one of said first and second user units to log the transfer of digital media data flies is also provided. Each user unit includes a respective user data management unit for limiting access to transferred media files and providing access to received media files.

In yet another configuration, the current invention is embodied in a computer program product. The computer program product may be stored on a computer readable recording medium and includes a computer readable code portions for transferring a media file or associated usage rights data from a first user unit to a second user unit, where the media file is identifiable by a central interface unit and includes at least one component of image data, audio data, and video data. It also comprises computer readable program code portions for initiating a direct communication link between the first and second user units, computer readable program code portions for transferring at least one of the media file or the associated usage rights data from the first user unit to the second user unit, computer readable program code portions for limiting access by the first user unit to the media file, computer readable program code portions for providing access to the second user unit to the media file, computer readable program code portions for coupling at least one of the first and second user units over a communications network to the central interface unit, and computer readable program code portions for logging, at the central interface unit, the transfer of the media file (from the first user unit) to the second user unit.

### BRIEF DESCRIPTION OF THE DRAWINGS

In the following the invention will be described with reference to exemplary embodiments illustrated in the figures, in which:

FIG. 1 is a schematic diagram illustrating the interrelationship among the major components of the invention;

FIG. 2 is a schematic diagram illustrating a more detailed interrelationship among the major components of the invention according to a first embodiment of the invention;

FIG. 3 is a process flow diagram according to a second embodiment of the invention;

FIG. 4 is a process flow diagram according to a third embodiment of the invention; and

FIG. 5 is a process flow diagram according to a fourth embodiment of the invention.

### DETAILED DESCRIPTION OF PREFERRED EMBODIMENTS

In the following description, for purposes of explanation and not limitation, specific details are set forth, such as particular sequences of steps and various configurations, etc. In order to provide a thorough understanding of the present invention. It will be apparent to one skilled in the art that the present invention may be practiced in other embodiments that depart from these specific details. Moreover, those skilled in the art will appreciate that the functions explained herein below may be implemented using software functioning in conjunction with a programmed microprocessor or general purpose computer, and/or using an application specific integrated circuit (ASIC). It will also be appreciated that while the current invention is primarily described as a method, it may also be embodied in a computer program product as well as a system comprising a computer processor and a memory coupled to the processor, where the memory is encoded with one or more programs that may perform the methods disclosed herein.

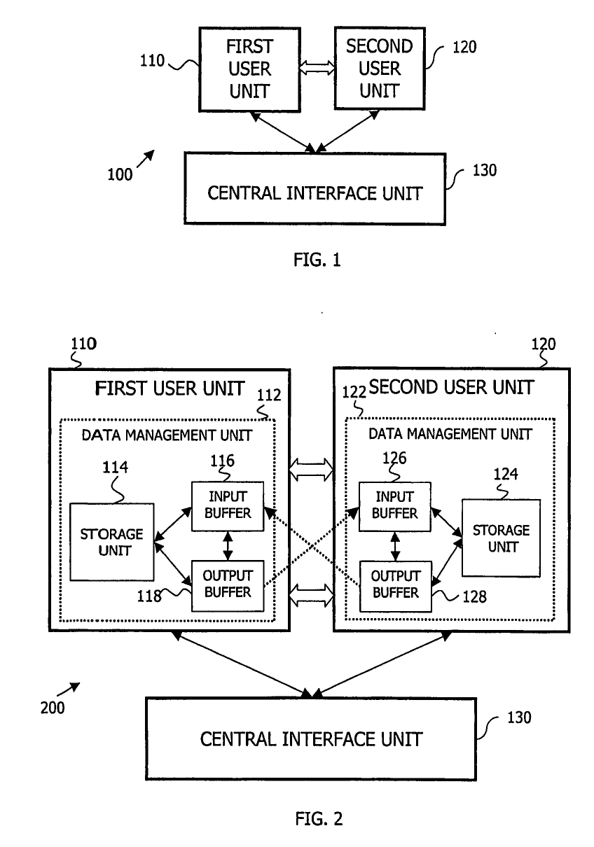

FIG. 1 illustrates the minimum number of components utilized in connection with the current invention, namely a first user unit 110 that contains a media file (like a digital trading card, electronic stickers, etc.) and associated usage rights data that identify the usage rights of the first user unit to the media file, a second user unit 120 that is configured to receive at least one of the media file and the associated usage rights data, and a central interface unit 130. It should be noted that the usage rights data could additionally or solely be stored by the central interface unit 130. The user units 110, 120 may be any instrument that is capable of storing and/or viewing a media file (such as a mobile communications device) and are configured to permit a direct communication link (that is preferably secure) with other user units (Bluetooth, infrared protocols, WLAN, cellular networks, etc.) during operation.

The central interface unit 130 is a device that is capable of maintaining information regarding the transfer of the media files. The central interface unit 130 includes applications that record, monitor and oversee the transfer of media files associated with each user unit 110, 120 (or alternatively, the applications focus on the media files themselves). The central interface unit 130, may also, in some variations, store copies of the media files and/or the associated usage rights data for each such media file so that a user may access his or her collection of media files as well as any related account history or central interface unit account information. With these variations, a receiving user unit that receives only one of the media file and the associated usage rights data may subsequently coupled to the central interface unit 130 to obtain the other needed file to access and utilize the media file. In yet other variations, the central interface unit 130 includes a transaction database (not shown) for each user unit which may be used for storing information such as for determining popularities of certain media files and for charging the user of each user unit for each media file transfer.

In the present embodiment, the user units 110, 120 are mobile communications devices, such as mobile phones. A graphical user interface (not shown) on the user units 110, 120 allows the user to view, exchange, receive, lend, sell, borrow, or otherwise transfer media files (such as digital trading cards, e-cards, e-stickers and the like). The transactions provided by the user units 110, 120 may be independent of any underlying service provider. For example, a mobile phone user may transfer at least one of a media file and associated usage rights data directly to another user unit without accessing the phone service provider's network or it may, alternatively, directly transfer and receive data over a data communications network (such as the phone service provider's network) without prior review and/or approval from the central interface unit 130. However, although each user unit 110, 120 may also be configured to directly communicate with the central interface unit, in the present embodiment each user unit 110, 120 is operable on a communications network (e.g., the Internet, or a mobile phone service) to allow each user unit 110, 120 to couple with the central interface unit 130 over the communications network.

FIG. 2 illustrates another embodiment of the current invention 200 with specifically configured user units 110, 120, each having a data management unit 112, 122, and a central interface unit 130. Also included are respective storage units 114, 124, in which the media files as well as the associated usage rights data are stored (and where they are accessed when used by the user units). Preferably, the storage units are a non-volatile memory such a read-only memory and flash memory. Each user unit also includes an input buffer 116, 126 which acts as a buffer to receive media files, as well as an output buffer 118, 128 in relation to the transfer of media files.

The data management units 112, 122 control the operation as well as access of the user units 110, 120 to their respective storage units 114, 124, input buffers 116, 126 and output buffers 118, 128. When it has been determined that a media file stored within the storage units 114, 124 is to be transferred, an application within the user units 110, 120 (which may or may not be external to the respective data management unit 112, 122) transfers the media file from the storage unit to the output buffer 118, 128 from where it is subsequently transferred to the input buffer 116, 126 of the receiving user unit 110, 120 (over whatever communication pathway has been established between the two user units). This transfer may be based on a variety of triggering conditions including a command entered into a user unit 110, 120 by a user as well as well as the return of a media file if there were any restrictions on usage placed on the media file within the associated usage rights data. The data management units 112, 122 may also act to provide or prevent access to a media file within the storage unit 114, 124 after transfer of such media file (by deleting the media file or otherwise restricting access to it by other applications in one of the user units 110, 120 including the graphical user interface).

In those arrangements in which media files or associated usage rights data are being swapped, the respective data management units 112, 122 will move the media file to be transferred out of the storage unit 114, 124 into the output buffer 118, 128. After it is confirmed that (i) a first user unit 110 has received at least one of the media file and the associated usage rights data from the second user unit 120 in its respective input buffer 116; and (ii) the second user unit 120 has received at least one of the media file and the associated usage rights data from the first user unit 110 in its respective input buffer 126, the data management units 112, 122 may then instruct that the transferred at least one media file and associated usage rights data be transferred from the respective input buffers 116, 126 to the storage units 114, 124. Subsequently, the buffers may then be initialized to facilitate the receipt of further media files either from the respective storage units 114, 124, in the case of the output buffers 118, 128, or via a communications pathway, in the case of the input buffers 114, 124. In some arrangements, if the transfer is not successful (e.g., communication pathway is disconnected, or no digital file is received in the case of a swap) or is subsequently cancelled, the media files are returned to the output buffers 118, 128 of the respective user units 110, 120 in which the media files originated. The present invention may also accommodate transfers of more than one media file by either user to the other as part of a swap transaction.

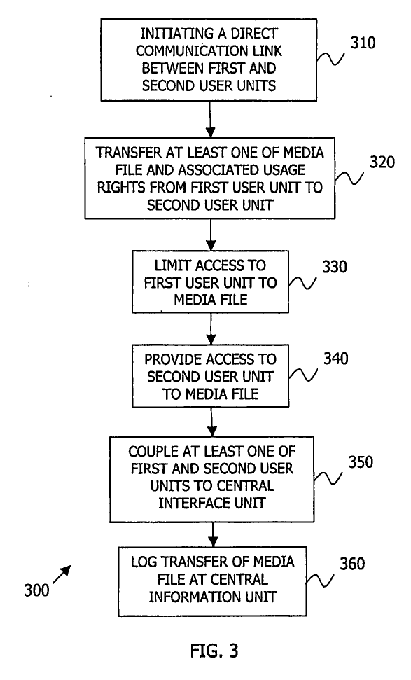

FIG. 3 illustrates a method 300 according to another embodiment of the current invention. Initially, at step 310 a communication link or pathway directly connecting first and second user units is established. After the communications link is initiated, at step 320, at least one of a media file and its associated usage rights data is transferred from the first user unit to the second user unit. At step 330, access by the first user unit is limited to the transferred media file to avoid duplicated use of the media file (and to maintain the desirable characteristics of the media file). At step 340, the second user unit is provided access to the transferred media file or the ability to access to the transferred media file if only the associated usage rights data was transferred (requiring the second user unit to subsequently obtain the media file either from the first user unit, the central interface unit, or another depository containing the underlying media file). Next, at step 350, at least one of the first and second user units is coupled to the central interface unit, to log, at step 360, the transfer of the media file (and/or its associated usage rights data) from the first user unit to the second user unit.

Steps 320 and 330 as well as steps 330 and 340 could be performed in a different order. Moreover, steps 350 and 360 could be performed earlier, e.g. directly after step 320.

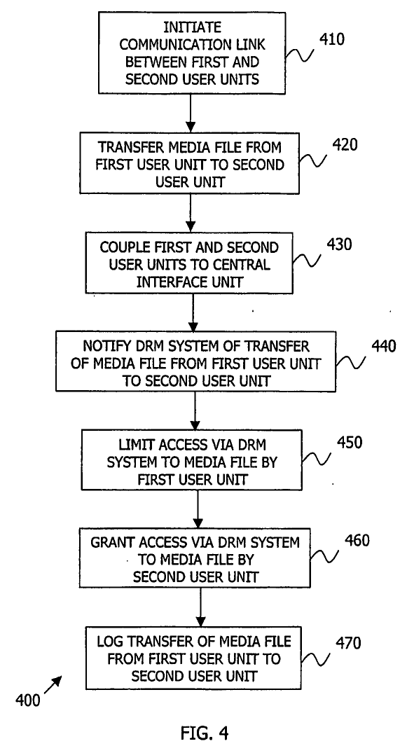

FIG. 4 illustrates another embodiment of a method 400 in connection with the current invention. Similar to previous embodiments, the method commences at step 410 with the initiation of communications directly between the first and second user units. At step 420, at least one of the media file and its associated usage rights data is transferred from the first user unit to the second user unit. In contrast with the methods above, the next step 430 couples the first and second user units to the central interface unit which includes a digital rights management system. The digital rights management can be performed by a lava application.

After the user units are coupled to the central interface unit, at least one of the first and second user units notifies the digital rights management system within the central interface unit of the transfer of the media file from the first user unit to the second user unit. The DRM system, at step 450, verifies that the transferring user unit has rights to the media file, and then sends a command to the first user unit (which may have a corresponding data management unit) to limit (either partially or wholly) access to the media file by the first unit. Either before, coincidentally or subsequently, the digital rights management system, at step 460, then provides access to the media file by the second user unit. Finally, at step 470, the transfer of the media file from the first user unit to the second user unit is logged at the central interface unit to record the new location/owner of the digital media file. Alternatively, the media file may be transferred prior to the polling of the digital rights management system, provided that actual usage of the transferred media file by the second user unit is conditioned upon an approval command or condition as set by the digital management system.

The digital rights management system may utilize protocols such as Open Mobile Alliance Digital Rights Management version two (OMA DRM v2), as well as other protocols in which the rights to use (and in some embodiments the rights to transfer) are granted by the digital rights management system. Using OMA DRM v2, the associated usage rights data is integral to the access and use of a digital media file and are cryptographically bound to the user unit such that only the digital rights management system can approve the transfer of a media file. This arrangement requires that each media file have a unique identification so that media files may not be duplicated or otherwise reproduced without authorization.

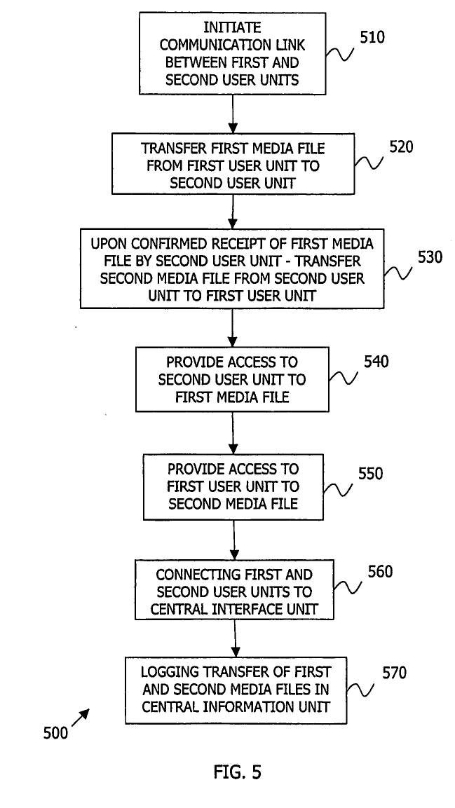

FIG. 5 illustrates yet another embodiment of the current invention in the form of a method 500 wherein two user units swap media files (which may be utilized in conjunction with a system as in FIG. 2 or otherwise). At step 510, a communication link is established between the first and second user units each having a media file and associated usage rights data. At least one of a first media file and associated usage rights data is transferred, at step 520, from the first user unit to the second user unit. Upon the confirmed receipt of the at least one of first media file and associated usage rights by the second user unit, at step 530, at least one of a second media file and associated usage rights data is transferred from the second user unit to the first user unit. At step 540, the second user unit is provided access to the first media file, and at step 550, the first user unit is provided access to the second media file (and the user units may also limit access to the media files transferred therefrom).

At step 560, at least one of the first and second user units are connected to the central interface unit 560 to permit the central interface unit, at step 570, to log the transfer of the at least one of media file and associated usage rights data to each user unit. In some variations of this method, the second user unit does not have a media file or associated usage rights data to swap with the first user unit, and so a dummy media file and/or dummy associated usage rights data is generated so that the first user unit will receive a file or data that appears to comply with the condition that a transaction involved the swapping of data files (except that the media file and associated usage rights data have little or no content). Alternatively, this variation of the method may allow both parties to exchange at least one of media files and associated usage rights data and have a subsequent verification or other ratification of the transaction.

While the present invention has been described with respect to particular embodiments (including certain system arrangements and certain orders of steps within various methods), those skilled in the art will recognize that the present invention is not limited to the specific embodiments described and illustrated herein. Therefore, while the present invention has been described in relation to its preferred embodiments, it is to be understood that this disclosure is only illustrative. Accordingly, it is intended that the invention be limited only by the scope of the claims appended hereto.

1.-20. (canceled)

21. A method for transferring at least one of a media file and associated usage rights data from a first user unit to a second user unit, wherein the media file is identifiable by a central interface unit and includes at least one component of image data, audio data, and video data, the method comprising the steps of:
transferring at least one of the media file and the associated usage rights data directly from the first user unit to the second user unit via a communication link between the first and second user units;
limiting access by the first user unit to the media file;
providing access to the second user unit to the media file;
coupling at least one of the first and second user units over a communications network to the central interface unit; and
logging, at the central interface unit, the transfer of at least one of the media file and its associated usage rights data to the second user unit.

22. The method of claim 21, further comprising the step of retrieving, by the second unit, either the media file or the associated usage rights data, not transferred from the first user unit to the second user unit from the central interface unit.

23. The method of claim 21, wherein the second user unit has a second media file with associated usage rights data, the method further comprising the steps of:
transferring at least one of the second media file and its associated usage rights data from the second user unit to the first user unit;
limiting access by the second user unit to the second media file;
providing access to the first user unit to the second media file;
wherein the logging step further comprises the step of logging the transfer of at least one of the second media file and its associated usage rights data from the second user unit to the first user unit.

24. The method of claim 23, wherein the transfer of at least one of the first media file and its associated usage rights data to the second user unit is part of a swap transaction conditioned upon the transfer of at least one of the second media file and its associated usage rights data to the first user unit.

25. The method of claim 23, wherein the second user unit transfers more than one media file to the first unit as part of a swap transaction.

26. The method of claim 24, further comprising the step of generating a dummy media file substituting at least one of the second media file and its associated usage rights data to satisfy the swap transaction conditions.

27. The method of claim 21, wherein the first and second user unit each has a storage unit, an input buffer and an output buffer, the method further comprising the steps of:
transferring the media file to be transferred from the storage unit of the first user unit (a transferring user unit) to the associated output buffer; and
transferring the media file to be transferred from the output buffer of the transferring user unit to the input buffer of the second user unit (a receiving user unit).

28. The method of claim 27, wherein the logging step additionally comprises at least one of:
updating a transfer log associated with the transferring user unit to reflect the removal of the media file; and
updating a transfer log associated with the receiving user unit to reflect the addition of the transferred media file.

29. The method of claim 27, further comprising the steps of:
polling a digital rights management system within the central interface unit by the transferring user unit; and
receiving a command or message from the digital rights management system by the transferring user unit to limit access by the transferring user unit to the transferred media file.

30. The method of claim 27, further comprising the steps of:
polling a digital rights management system within the central interface unit by the receiving user unit; and
receiving a command or message from the digital rights management system by the receiving user unit to grant to the receiving user unit access to the received media file.

31. The method of claim 27, further comprising the step of preventing access to a transferred media file by a receiving user if the digital rights management system has associated the transferred media file with a third user unit.

32. The method claim 27, further comprising the step of cryptographically associating each transferred digital media file with a receiving user unit.

33. The method of claim 27, further comprising the step of transferring the transferred media file from the receiving user unit back to the transferring unit if the transfer is not ratified.

34. The method of claim 27, further comprising the steps of:
providing a history log for integration into each media file that identifies at least one of previous owners and transfers of the media file; and
synchronizing the media file history log with the logged transfers stored within the central interface unit.

35. The method of claim 27, further comprising the step of determining whether the media file is transferred with one or more usage restrictions.

36. The method of claim 27, further comprising the step of transferring the transferred media file from the receiving user unit back to the transferring user unit after a predetermined usage restriction condition associated with the transferred media file has been met.

37. The method of claim 27, further comprising the step of transferring the transferred media file from the receiving user unit back to the transferring user unit after a predetermined amount of time has expired, or after the receiving user unit has accessed the transferred media file greater than or equal to a predetermined number of occurrences, or if the transfer has not been ratified by the central interface unit, or if the transfer is subsequently cancelled, or if the transfer is not successful.

38. The method of claim 27, further comprising the step of periodically communicating, by the central interface unit, with individual user units, to synchronize at least one of the media files and the associated usage rights data, if any, stored within each user unit with one or more databases within the central interface unit.

39. A system for transferring a media file that includes at least one component of image data, audio data, and video data, and associated usage rights data, comprising:
a first user unit configured to store at least one digital media file;
a second user unit configured to store at least one digital media file;
wherein said first and second user units are configured to initiate a communications link between the first and second users units to transfer at least one of a media file or associated usage rights data therebetween;
a central interface unit configured to communicate with at least one of said first and second user units to log the transfer of digital media files;
a first data management unit within said first user unit for limiting access to media files transferred by said first user unit; and
a second data management unit within said second user unit for providing access to media files received by said second user unit.

40. A computer program product, comprising:
a computer usable medium having computer readable code embodied therein for transferring at least one of a media file or associated usage rights data from a first user unit to a second user unit wherein the media file is identifiable by a central interface unit and includes at least one component of image data, audio data, and video data, the computer code product comprising:
computer readable program code portions for transferring at least one of the media file and the associated usage rights data from the first user unit to the second user unit over a communication link between the first and second user units;
computer readable program code portions for limiting access by the first user unit to the media file;
computer readable program code portions for providing access to the second user unit to the media file;
computer readable program code portions for coupling at least one of the first and second user units over a communications network to the central interface unit; and
computer readable program code portions for logging, at the central interface unit, the transfer of the media file to the second user unit.

41. The computer program product of claim 40, stored on a computer readable recording medium.

42. A system comprising a computer processor and a memory coupled to the processor, where the memory is encoded with one or more programs that is configured to perform a method for transferring at least one of a media file and associated usage rights data from a first user unit to a second user unit, wherein the media file is identifiable by a central interface unit and includes at least one component of image data, audio data, and video data, the method comprising the steps of:
transferring at least one of the media file and the associated usage rights data directly from the first user unit to the second user unit over a direct communication link between the first and second user units;
limiting access by the first user unit to the media file;
providing access to the second user unit to the media file;
coupling at least one of the first and second user units over a communications network to the central interface unit; and
logging, at the central interface unit, the transfer of at least one of the media file and its associated usage rights data to the second user unit.
